(19) United States
(12) Patent Application Publication
(10) Pub. No.: US 2012/0224554 A1
(43) Pub. Date: Sep. 6, 2012

(54) APPARATUS AND METHOD FOR ASSIGNING LAYERS IN WIRELESS COMMUNICATION SYSTEM

(75) Inventor: Kyoungmin Park, Goyang-si (KR)

(73) Assignee: PANTECH CO., LTD., Seoul (KR)

(21) Appl. No.: 13/505,427

(22) PCT Filed: Nov. 1, 2010
(86) PCT No.: PCT/KR2010/007583

§ 371 Date: May 1, 2012

(30) Foreign Application Priority Data
Nov. 2, 2009 (KR) 10-2009-0105176

(51) Int. Cl. H04W 72/04

(52) U.S. Cl. 370/329

(57) ABSTRACT

Disclosed are a method and an apparatus for assigning layers which assure a high data rate, considering interference among layers and interference among terminals in a wireless communication system. The present invention comprises: a layer composition unit for composing layers to assign at least one layer in each of at least two terminals; and a layer change unit for changing the assignment of the layers due to the interference by receiving the information for the interference between the layers of at least two terminals.

### CROSS REFERENCE RELATED APPLICATIONS

This application is the National Stage Entry of International Application PCT/KR2010/007583, filed on Nov. 1, 2010, which claims priority from and the benefit of Korean Patent Application No. 10-2009-0105176, filed on Nov. 2, 2009, both of which are herein incorporated by reference for all purposes as if fully set forth herein.

### BACKGROUND

1. Field

The present invention relates to scheduling of a base station (BS) in a wireless communication system, and more particularly, to a method and apparatus for assigning at least one layer to a user equipment (UE).

2. Discussion of the Background

One of the most important requirements for a next generation wireless communication system is a capability of supporting a high required data transmission rate. A communication capacity may be readily improved by increasing a bandwidth used by a communication system. However, the approach may be difficult to be employed due to physical or practical drawbacks. Accordingly, recent communication systems may pursue an increase in the communication capacity by effectively using a limited bandwidth through use of various technologies such as a multiple input multiple output (MIMO), a cooperative multiple point transmission and reception (CoMP), a relay, and the like.

### SUMMARY

An aspect of the present invention is to provide a method and apparatus for assigning at least one layer to a user equipment (UE) in a wireless communication system.

Another aspect of the present invention is to provide a layer assigning method and apparatus that assures the most of a service request from a UE.

Another aspect of the present invention is to provide a method and apparatus for assigning layers by combining a pair of layers, in which mutual interference occurs, with a layer distinguished from the pair in a wireless communication system.

Another aspect of the present invention is to provide a method and apparatus for assigning layers by adjusting interference among layers and interference among UEs in a wireless communication system.

Another aspect of the present invention is to provide a method and apparatus for cancelling interference by taking into consideration a pair of layers in which mutual interference occurs and a layer distinguished from the pair in a wireless communication system.

In accordance with an aspect of the present invention, there is provided a base station (BS) in a wireless communication system in which at least two user equipments (UEs) perform multiple access with respect to the BS, the BS including: a layer composition unit to arrange layers so that at least one layer is assigned to each of the at least two UEs; and a layer change unit to receive information associated with interference between layers of the at least two UEs, and to change the assignment of layers, in which interference occurs, with respect to the at least two UEs.

In accordance with another aspect of the present invention, there is provided a communication method for a BS to communicate with UEs in a wireless communication system in which at least two UEs perform multiple access with respect to the BS, the method including: assigning at least one layer to each of the at least two UEs so as to communicate with the at least two UEs; and assigning layers in which interference occurs to at least one of the at least two UEs when interference occurs between the layers of the at least two UEs.

### BRIEF DESCRIPTION OF THE DRAWINGS

FIG. 1 is a diagram illustrating a wireless communication system according to an embodiment of the present invention;

FIGS. 2, 4, 6, and 7 are diagrams illustrating a communication process performed between a base station (BS) and a user equipment (UE) according to an embodiment of the present invention;

FIG. 3 is a block diagram illustrating a wireless communication system including a BS that assigns a layer through use of a channel status report received from a UE according to an embodiment of the present invention;

FIG. 5 and FIG. 8 are block diagrams illustrating layer assignment performed by a BS according to an embodiment of the present invention;

FIG. 9 is a block diagram illustrating a configuration of a wireless communication system including a BS that assigns a layer through use of a channel status report from a UE according to another embodiment of the present invention;

FIG. 10 is a block diagram illustrating a configuration of a wireless communication system including a BS that assigns a layer through use of MAI from a UE according to another embodiment of the present invention;

FIGS. 11 through 14 are diagrams illustrating a communication method for a BS to communicate with a UE according to another embodiment of the present invention; and

FIG. 15 is a diagram illustrating a scheduling process that assigns a layer based on interference among layers according to an embodiment of the present invention.

### DETAILED DESCRIPTION OF EXEMPLARY EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

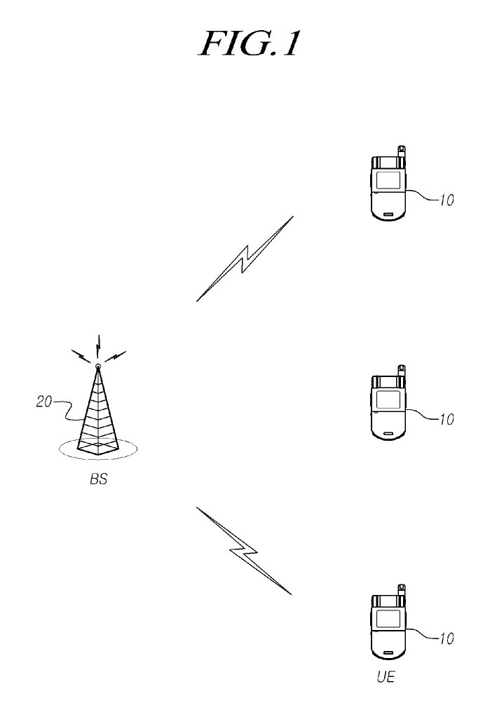

FIG. 1 illustrates a wireless communication system according to an embodiment of the present invention. The wireless communication system refers to a system that provides various communication services such as voice, packet data, and the like.

Referring to FIG. 1, the wireless communication system may include a user equipment (UE) 10 and a base station (BS) 20.

The UE 10 may be an inclusive concept indicating a user terminal in wireless communication, and the concept may include a UE in WCDMA, LTE, HSPA, and the like, a mobile station (MS), a user terminal (UT), a subscriber station (SS), a wireless device in GSM, and the like.

In general, the BS 20 or a cell may refer to a fixed station where communication with the UE 10 is performed, and may also be referred to as a Node-B, an evolved Node-B (eNB), a base transceiver system (BTS), an access point, and the like.

That is, the BS 20 or the cell may be an inclusive concept indicating a portion of an area covered by a base station controller (BSC) in CDMA and a Node B in WCDMA, and the concept may include coverage areas, such as a megacell, a macrocell, a microcell, a picocell, a femtocell, and the like.

The UE 10 and the BS 20 are used as two inclusive transceiving subjects to embody the technology and technical concepts described in the specifications, and may not be limited to a predetermined term or word.

A multiple access scheme applied to the wireless communication system is not limited. The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like.

Uplink transmission and downlink transmission may be performed based on a time division duplex (TDD) scheme that performs transmission based on different times, or based on a frequency division duplex (FDD) scheme that performs transmission based on different frequencies.

Embodiments of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. The embodiments of the present invention may not be limited to a specific wireless communication, and may be applicable to all technical fields to which a technical idea of the present invention is applicable.

Hereinafter, the embodiments of the present invention may provide a precoding method and a channel information feedback method, which support an MU-MIMO scheme that simultaneously transmit information to UEs through use of a multi-antenna.

In particular, a layer assignment scheme that effectively adjusts interference among layers and interference among UEs so as to obtain a high throughput in a wireless communication system using a multi-antenna will be described. Also, interference cancellation (IC) that cancels interference between layers assigned to each user may be performed by taking into consideration a precoding scheme that assigns at least two layers for each user. When a layer is assigned to each UE, each UE may perform IC to cancel interference between assigned layers. Based on this, a BS may selectively assign a layer available for the same UE and a layer available for each UE.

Through the descriptions provided in the foregoing, a larger IC gain and a larger scheduling gain may be obtained when compared to a conventional beam forming scheme that assigns only a single layer to each user, and a scheme that assigns a layer to each UE only based on a characteristic of the layer, irrespective of a user.

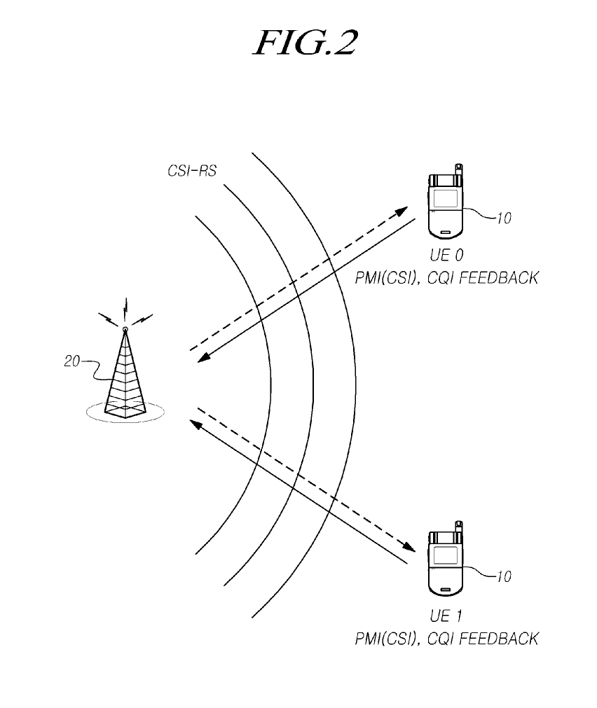

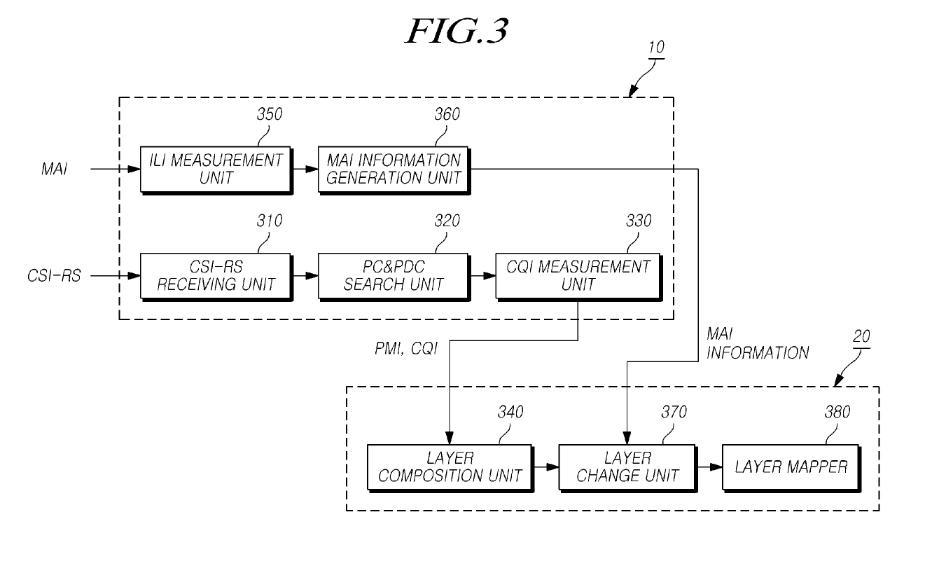

FIG. 2 illustrates a wireless communication system that transmits information to two or more UEs through use of a multi-antenna according to an embodiment of the present invention. FIG. 3 illustrates a wireless communication system in which a UE transmits a channel status information report to a BS, and the BS assigns a layer based on the channel status information report according to an embodiment of the present invention.

In particular, according to embodiments of the present invention, a UE transmits a channel status report to a BS through codebook-based precoding, and the BS assigns layers to each UE based on a corresponding channel status report, and assigns layers, in which inter-layer interference (ILI) occurs, to the same arbitrary UE.

Referring to FIGS. 2 and 3, the BS 20 may transmit information to two or more UEs 10 through use of a multi-antenna. In this example, although the two or more UEs 10 that perform multiple access with respect to the BS 20 are described as, for example, two UEs, that is, UE0 and UE1, the two or more UEs 10 may not be limited thereto.

After each UE (UE0 and UE1) performs multiple access with respect to the BS 20, each UE may receive a channel status information-reference signal (CSI-RS) (CSI-RS receiving unit 310) when the BS 20 transmits the CSI-RS corresponding to a common reference signal for channel estimation.

Each UE (UE0 and UE1) may periodically or aperiodically provide a channel status report to the BS 20. The channel status report may not explicitly report a downlink channel status, but may provide a transmission configuration to be used when the BS 20 performs transmission to a UE and recommendations associated with related parameters depending on the instantaneous downlink channel conditions.

When a codebook based precoding is utilized, each UE (UE0 and UE1) may search for precoder matrix information (PMI) indicating a precoding scheme and a precoder matrix appropriate for a downlink channel as a channel status report (PC & PDC search unit 320).

Also, each UE (UE0 and UE1) may measure channel quality information (CQI) indicating an expected channel quality as a channel status report (CQI measurement unit 330). In this example, each UE (UE0 and UE1) may measure the received CSI-RS so as to measure the CQI. The CQI may include a modulation scheme and a coding rate appropriate for a downlink channel. The CQI may recommend a modulation scheme and a coding rate appropriate for a downlink channel based on a scheme that designates a table including modulation schemes and coding rates.

Each UE (UE0 and UE1) may report the retrieved PMI and the measured CQI to the BS 20.

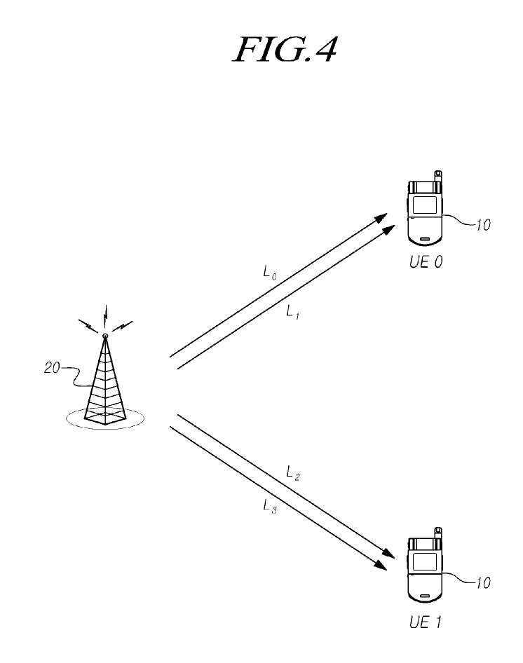

FIG. 4 illustrates that a wireless communication system assigns layers according to an embodiment of the present invention.

Referring to FIG. 4, the BS 20 may receive, from the UE 10, for example, UE0 and UE1, PMI indicating a precoder matrix and precoding scheme appropriate for a downlink channel and CQI indicating expected channel quality, as a channel status report.

The BS 20 may arrange layers appropriate for each UE (UE0 and UE1), based on a channel status report received from each UE, for example, PMI and CQI (layer composition unit 340). The BS 20 may assign layers to each UE (UE0 and UE1) based on the arrangement, and may determine a precoding matrix so as to perform precoding of symbols.

When a total sum of a number of layers required by each UE (UE0 and UE1) is greater than a number of layers that the BS 20 is able to transmit, the BS 20 may assign a smaller number of layers to each UE (UE0 and UE1) than the number of layers required by each UE (UE0 and UE1).

In this example, when the BS 20 transmits a signal to each UE (UE0 and UE1) through multiple layers, the BS 20 may perform precoding of the symbols based on a precoding matrix that minimizes inter-layer interference (ILI) received by each UE (UE0 and UE1).

For example, the BS 20 may assign two layers L₀ and L₁ to UE0, and may assign two layers L₂ and L₃ to UE1. In this example, the BS 20 may perform precoding of a symbol based on a 4×Nt precoding matrix, Nt denoting a number of four or more antennas of BS.

When the BS 20 assigns layers to each UE (UE0 and UE1), the BS 20 may perform assignment to minimize ILI. Also, the BS 20 may perform assignment to minimize inter-UE interference or to enable each UE to have the greatest reception performance.

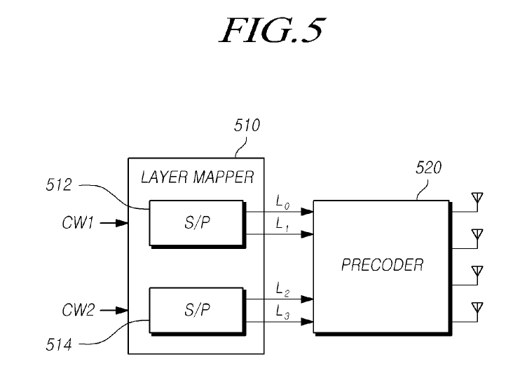

FIG. 5 illustrates a BS that assigns a layer according to an embodiment of the present invention.

Referring to FIG. 5, the BS 20 may include a layer mapper 510 and a precoder 520. The layer mapper 510 may map codewords CW1 and CW2 to be transmitted to UEs (UE0 and UE1) to two layers L₀ and L₁ and two layers L₂ and L₃, respectively, through use of at least one of a serial to parallel converter (S/P converter), for example, an S/P converter 512 and an S/P converter 514.

When a signal is transmitted to each UE (UE0 and UE1) through use of four antennas, the precoder 520 may perform precoding of codewords CW1 and CW2 mapped to the layers L₀ and L₁, and the layers L₂ and L₃, through use of a 4×4 precoding matrix, and may transmit the precoded codewords to the UEs (UE0 and UE1) through use of four antenna ports.

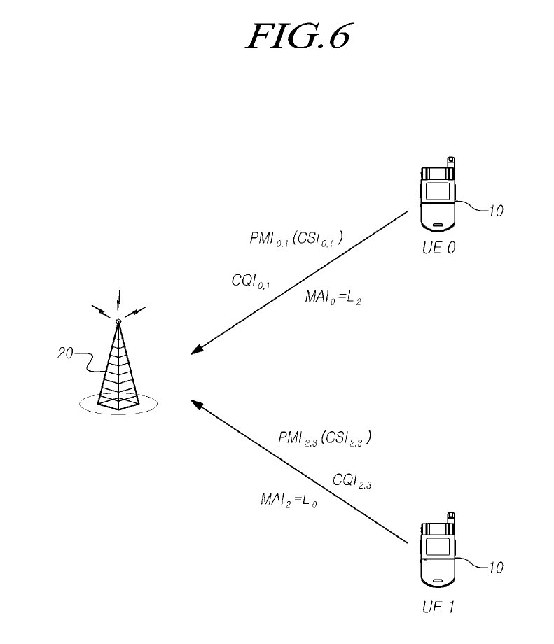

FIG. 6 illustrates a process that a UE reports multiple access interference (MAI) to a BS in a wireless communication system according to an embodiment of the present invention.

Referring to FIGS. 3 and 6, each UE (UE0 and UE1) may periodically or aperiodically provide PMI (PMI_{0.1}PMI_{2.3}) and CQI (CQI_{0.1}CQI_{2.3}) to the BS 20, as a channel status report. In this example, each UE (CQI_{0.1},CQI_{2.3}) may provide, to the BS 20, a single piece of CQI, a single piece of CQI per layer, or plural pieces of CQI and PMI. In particular, UE0 may provide, to the BS 20, PMI_{0.1} indicating a precoder matrix or a precoding scheme appropriate for a downlink channel associated with two desired layers L₀ and L₁ and CQI_{0.1} indicating expected channel quality of the two desired layers L₀ and L₁. In this example, UE0 may provide, to the BS 20 as a single piece of PMI, a single piece of PMI_{0.1} indicating the precoder matrix or the precoding scheme appropriate for the downlink channel associated with the two desired layers L₀ and L₁, or may provide, to the BS 20, plural pieces of PMI, for example, two pieces of PMI. Also, UE0 may provide, to the BS 20 as a single piece of CQI, a single piece of CQI_{0.1} indicating the expected channel quality of the two desired layers L₀ and L₁, or may provide, to the BS 20, plural pieces of CQI, for example, two pieces of CQI.

In this manner, UE1 may provide, to the BS 20, PMI_{2.3} indicating a precoder matrix or a precoding scheme appropriate for a downlink channel associated with two desired layers L₂ and L₃ and CQI_{2.3} indicating expected channel quality of the two desired layers L₂ and L₃. In this example, UE1 may provide, to the BS 20 as a single piece of PMI, a single piece of PMI_{2.3} indicating the precoder matrix or the precoding scheme appropriate for the downlink channel associated with the two desired layers L₂ and L₃, or may provide, to the BS 20, plural pieces of PMI, for example, two pieces of PMI. Also, UE1 may provide, to the BS 20 as a single piece of CQI, a single piece of CQI_{2.3} indicating the expected channel quality of the two desired layers L₂ and L₃, or may provide, to the BS 20, plural pieces of CQI, for example, two pieces of CQI.

Referring to FIG. 6, each UE (UE0 and UE1) may additionally transmit, to the BS 20, MAI information corresponding to information associated with interference, along with the channel status report.

Referring again to FIG. 3, each UE (UE0 and UE1) may receive, from the BS 20, a reference signal that estimates interference so as to measure inter-layer interference (ILI) from another UE (ILI measurement unit 350), may generate MAI information (MAI information generation unit 360), and may provide the generated MAI information to the BS 20.

For example, when interference occurs between the layer L₀ assigned to UE0 and the layer L₂ assigned to UE1, as illustrated in FIG. 6, UE0 may transmit, to the BS 20, MAI information MAI₀=L₂ indicating that interference occurs between the layer L₀ assigned to UE0 and the layer L₂.

UE1 may transmit, to the BS 20, MAI information MAI₂=L₀ indicating that interference occurs between the layer L₂ assigned to UE1 and the layer L₀.

That is, interference occurs between the layer L₀ assigned to UE0 and the layer L₂ assigned to UE1 and thus, the BS 20 may remove the layer L₀ assigned to UE0, may remove the layer L₂ assigned to UE1, or may remove both the layer L₀ and layer L₂.

However, removing the layer L₀ and the layer L₂ associated with interference unconditionally as described in the foregoing may have a drawback in that layers that the BS 20 is able to assign may be limited.

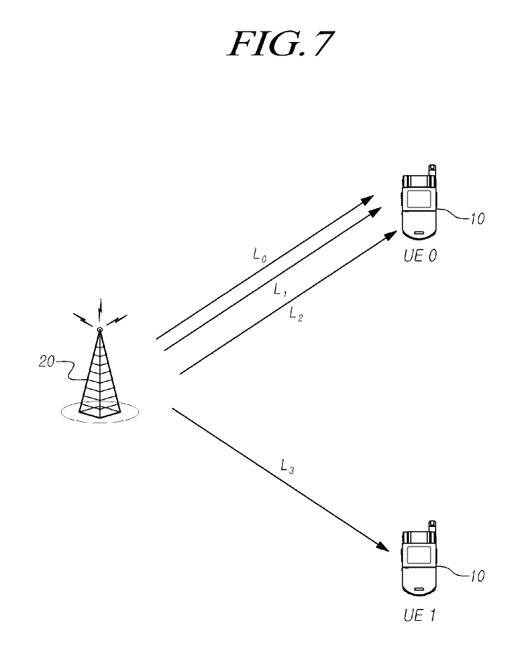

FIG. 7 illustrates a scheduling scheme that includes ILI, and assures, as much as possible, layer assignment with respect to another UE according to an embodiment of the present invention.

Referring to FIGS. 3 and 7, the BS 20 may change layers so that a layer L₀ and a layer L₂ are assigned to the same UE, for example, UE0 as illustrated in FIG. 7 (layer change unit 370), as opposed to removing transmission to UE0 through the layer L₀ or transmission to UE1 through the layer 2.

That is, when the BS 20 assigns layers to at least two UEs, the BS 20 may minimize ILI between UEs and the same UE (UE0 or UE1) may perform IC and thus, at least one layer that causes minimum interference may be assigned.

Therefore, the BS 20 may use all layers L₀ through L₃ that the BS 20 is able to assign even through ILI occurs and thus, may satisfy a high required data transmission rate which is one of the requirements of a next generation communication system. In this example, the BS 20 may enable layers causing mutual interference in the same UE to transmit data through use of a minimum transmission power. Conversely, the BS 20 may enable layers that do not interfere with other layers to transmit data through use of a maximum transmission power.

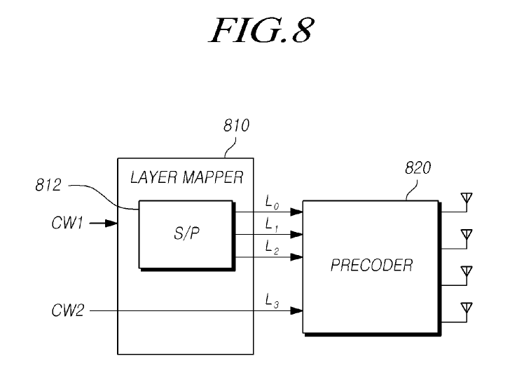

FIG. 8 illustrates a BS that assigns at least one layer with respect to the same UE according to an embodiment of the present invention. That is, FIG. 8 illustrates a base station that assigns layers in which interference occurs to the same UE, as illustrated in FIG. 7, when interference occurs between the layers assigned to UEs (UE0 and UE1).

Referring to FIG. 8, when interference occurs between a layer L₀ assigned to UE0 and a layer L₂ assigned to UE1, a layer mapper 810 of the BS 20 may map a codeword, for example, CW1, to the layers L₀ through the layer L₂ to be assigned to UE0 through use of a serial/parallel converter (S/P) 812. Also, the layer mapper 810 may map another codeword, that is, CW2, to a layer L₃ to be assigned to UE1. Here, CW2 assigned to the layer L₃ may be output through the S/P 812.

Existence of interference between the layer L₀ and the layer L₂ may indicate that the two UEs, UE0 and UE1, may receive the layer L₀ and the layer L₂. In this example, each UE (UE0 and UE1) may perform IC.

Therefore, UE0 to which the layers L₀ through L₂ are assigned may restore a layer that has a higher receiving sensitivity from among the layer L₀ and the layer L₂ that interfere with one another, may perform IC, and may decode all the three layers L₀, L₁, and L₂. Accordingly, the BS 20 may maximally increase a communication capacity associated with data transmission of a UE.

In other words, when interference occurs between layers assigned to each UE (UE0 and UE1), the BS 20 may determine whether to assign all the layers in which interference occurs to a predetermined UE. For example, the BS 20 may selectively assign a pair of layers that mutually interfere with one another, to a UE that requires a higher data rate based on a demand of a user, from among the UEs (UE0 and UE1).

Also, the BS 20 may compare throughputs of layers in which ILI does not occur, for example, a layer L₁ and a layer L₃, and may assign the layers L₀ and L₂ of layers, in which ILI does not occur, that mutually interfere with one another, to a UE with a smaller throughput than remaining UEs.

Accordingly, the BS 20 may additionally use the layers L₀ and L₂ that mutually interfere with one another, as opposed to discarding the layers L₀ and L₂ and thus, may maximally assure a data rate associated with service quality of each UE (UE0 and UE1).

The BS 20 may compare throughputs of the layer in which ILI does not occur, for example, the layers L₁ and L₃, and may assign the layers L₀ and L₂ of layers, in which ILI does not occur, that mutually interfere with one another to a UE with a higher throughput than remaining UEs. That is, a data rate associated with service quality of a UE that has a high throughput may be maximally assured.

In this example, although layers assigned to each UE (UE0 and UE1) are changed, a number of the layers may be the same and thus, a precoder 820 may perform precoding of a symbol based on a 4×Nt precoding matrix (wherein Nt denotes the number of antennas of four or more BSs).

Hereinafter, embodiments of the present invention may describe that, when codebook-based precoding is not used, a UE transmits a channel status report to a BS, the BS assigns layers to each UE based on a corresponding channel status report, and may assign layers in which ILI occurs to the same UE.

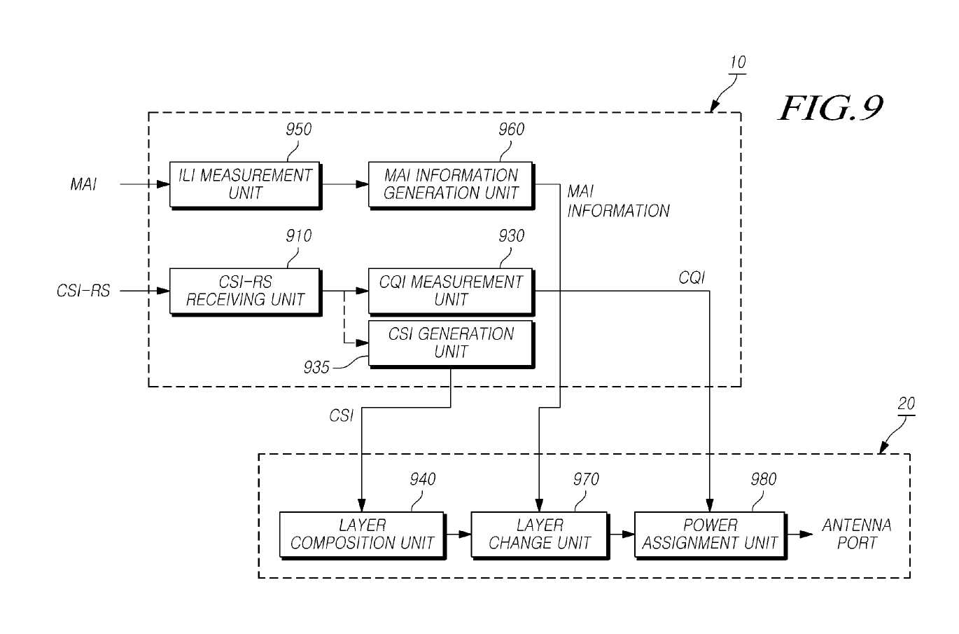

FIG. 9 illustrates a wireless communication system in which a UE transmits a channel status report to a BS when codebook-based precoding is not used according to another embodiment of the present invention. Description of components that are identical to the components described with reference to FIG. 3 will be omitted.

Referring to FIGS. 2 and 9, each UE (UE0 and UE1) may receive a CSI-RS corresponding to a common reference signal for channel estimation, and may measure CQI (CQI measurement unit 930).

Each UE (UE0 and UE1) may generate CSI based on the measured CQI, and may feed back the generated CSI to the BS 20 (CSI generation unit 935). In this example, each UE (UE0 and UE1) may feed back, to the BS 20, the CSI indicating channel information, as opposed to PMI. Here, the CSI generation unit 935 may be configured as a plurality of CSI generation units that are distinguished for each layer of a BS corresponding to a transmission side that performs transmission to a UE.

Accordingly, the BS 20 may arrange layers for each UE (UE0 and UE1) based on a channel status report received from each UE (UE0 and UE1), for example, CSI and CQI (layer composition unit 940), and may assign the layers to each UE. The BS 20 may precode a symbols of layers in which the least ILI occurs with a predetermined precoding scheme, based on the received channel status report.

The BS 20 may assign power for each layer after setting the precoding scheme (power assignment unit 980). In this example, the power assignment unit 980 may assign power for each layer based on the CQI fed back from the UE 10. When the power assignment unit 980 is not separately included, the BS 20 may provide the same amount of power to each layer.

When each UE (UE0 and UE1) receives MAI, and periodically or aperiodically reports a channel status, each UE (UE0 and UE1) may additionally measure ILI from another UE (ILI measurement unit 950), and may generate MAI information (MAI information generation unit 960). The MAI information may be fed back to the BS 20.

Accordingly, the BS 20 may assign layers to each UE (UE0 and UE1) by changing layers assigned to each UE (UE0 and UE1) based on the MAI information received from the UE.

When interference occurs between layers assigned to each UE (UE0 and UE1), the BS 20 may change layers so that layers in which interference occurs, for example, layers L₀ and L₂, are assigned to the same UE (layer change unit 970), as illustrated in FIGS. 7 and 8.

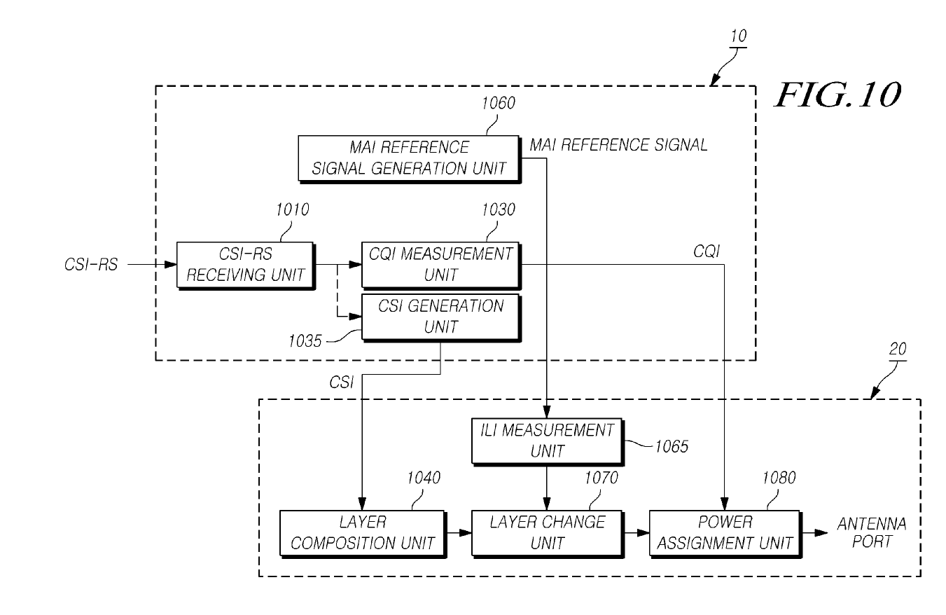

FIG. 10 illustrates a wireless communication system in which a UE transmits a reference signal for MAI measurement and a BS measures MAI, when codebook-based precoding is not used, according to another embodiment of the present invention.

Referring to FIGS. 6 and 10, when each UE (UE0 and UE1) periodically or aperiodically reports a channel status, each UE (UE0 and UE1) may additionally generate a MAI reference signal that estimates interference from the BS 20 (MAI reference signal generation unit 1060), and may transmit the MAI reference signal to the BS 20.

Accordingly, the BS 20 may receive the MAI reference signal, and may measure ILI from another UE based on the MAI reference signal (ILI measurement unit 1065), and may determine whether interference occurs between layers assigned to each UE (UE0 and UE1).

When interference occurs in the layers assigned to each UE (UE0 and UE1), the BS 20 may change the layers assigned to each UE (layer change unit 1070) so that the layers in which interference occurs are assigned to the same UE.

According to the embodiments of the present invention, when the BS 20 assigns four layers to two UEs (UE0 and UE1) and interference occurs between signals transmitted through the layers assigned to each UE (UE0 and UE1), layers in which interference occurs may be assigned to the same UE.

It is apparent that at least four layers may be variously applied to at least two UEs. That is, embodiments of the present invention may not be limited to conditions provided in the foregoing descriptions.

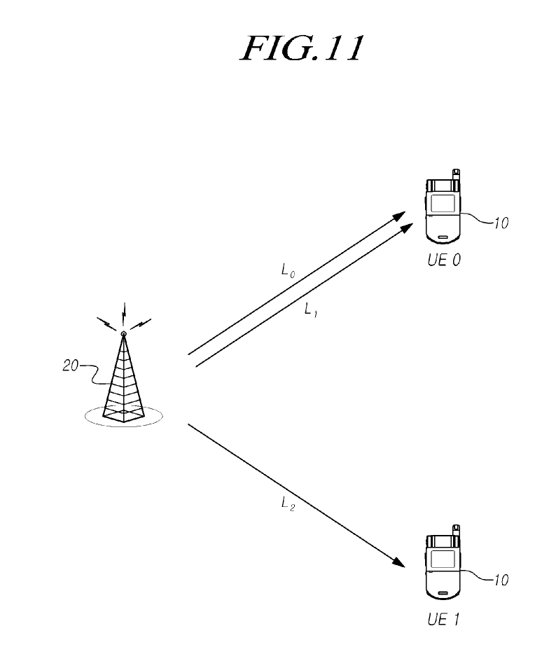

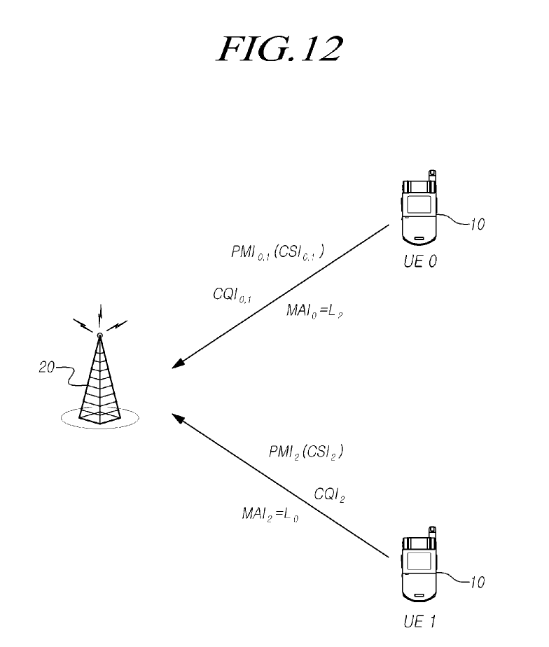

FIGS. 11 through 14 illustrate a process of assigning a layer according to another embodiment of the present invention.

Referring to FIGS. 11 through 14, when interference occurs between signals transmitted through layers assigned to two UEs (UE0 and UE1), the BS 20 may assign layers in which interference occurs to the same UE.

While the BS 20 assigns two layers L₀ and L₁ to UE0 and assigns a layer L₂ to UE1, as illustrated in FIG. 11, each UE (UE0 and UE1) may periodically or aperiodically provide, to the BS 20, PMI (PMI_{0.1} and PMI₂), CSI (CSI_{0.1} and CSI₂), or CQI (CQI_{0.1} and CQI₂) as a channel status report. In particular, UE0 may provide, to the BS 20, PMI_{0.1} indicating a precoder matrix or precoding scheme appropriate for a downlink channel associated with the two desired layers L₀ and L₁, CSI_{0.1} indicating downlink channel information, or CQI_{0.1} indicating expected channel quality of the two desired layers L₀ and L₁. In this example, UE0 may provide, to the BS 20, a single piece of PMI_{0.1} or CSI_{0.1} associated with the two desired layers L₀ and L₁ as a single piece of PMI or CSI, or may provide, to the BS 20, plural pieces of PMI or CSI, for example, two pieces of PMI or CSI. Also, UE0 may provide, to the BS, a single piece of CQI_{0.1} indicating the expected channel quality of the two desired layers L₀ and L₁ as a single piece of CQI, or may provide, to the BS 20, plural pieces of CQI, for example, two pieces of CQI.

In this manner, UE1 may provide, to the BS 20, PMI₂ indicating a precoder matrix or precoding scheme appropriate for a downlink channel associated with the single desired layer L₂, CSI_{0.1} indicating downlink channel information, or CQI₂ indicating expected channel quality of the single desired layer L₂. Also, each UE (UE0 and UE1) may additionally transmit, to the BS 20, MAI information corresponding to information associated with interference, along with the channel status report. In this example, interference may occur between a signal transmitted through the layer L₀ assigned to UE0 and a signal transmitted through the layer L₂ assigned to UE1.

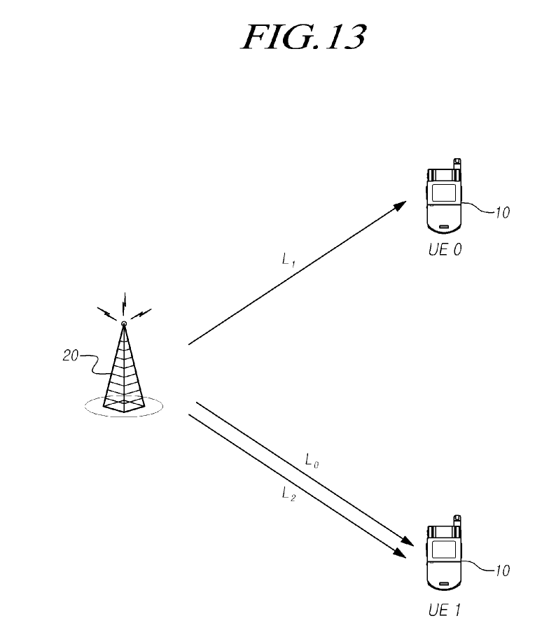

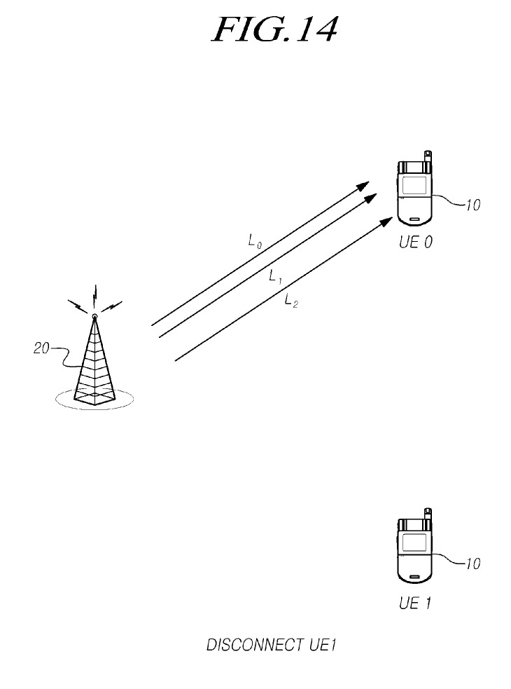

Accordingly, the BS 20 may assign the two layers L₀ and L₂ in which interference occurs, to UE1 or to UE0, as illustrated in FIGS. 13 and 14.

Here, when the two layers L₀ and L₂ in which interference occurs are assigned to UE0, UE1 may not have an assigned layer and thus, connection between UE1 and the BS 20 may be disconnected.

Accordingly, when interference occurs between layers assigned to each UE (UE0 and UE1), the BS 20 may determine a UE to which the layers, in which interference occurs, are to be assigned. The BS 20 may assign all the layers, in which interference occurs, to a UE that requires a higher data rate based on a demand of a user, from among the UEs (UE0 and UE1), or may assign at least one layer to each UE so that a UE that breaks connection with the BS 20 does not exist.

Although it is described that, when interference occurs between a layer assigned to UE0 and a layer assigned to UE1, the BS 20 may remove one of the layers assigned to the two UEs, may remove the two layers, or may assign the layers to the same UE, the embodiments of the present invention may not be limited thereto.

According to another embodiment of the present invention, there may be provided a communication method for a BS to communicate with UEs in a wireless communication system in which at least two UEs perform multiple access with respect to the BS, and the method may include assigning at least one layer to each of the at least two UEs so as to communicate with the at least two UES, assigning layers, in which interference occurs, to at least one of the at least two UEs when interference occurs between the layers of the at least two UEs, and removing one of layers, in which interference occurs, when interference occurring between the layers of the at least two UEs is greater than a predetermined threshold value.

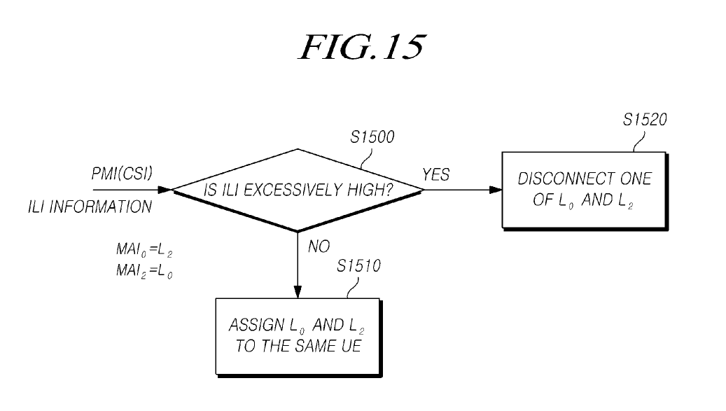

FIG. 15 illustrates a process of scheduling based on ILI according to another embodiment of the present invention. In particular, FIG. 15 illustrates that a BS assigns layers in which interference occurs to the same UE or does not use one of the layers, based on a magnitude of ILI.

Referring to FIG. 15, the BS may receive MAI information or an MAI reference signal from each UE (UE0 and UE1). In this example, the BS may determine whether layers that interfere with one another exist, based on the received MAI information or the MAI reference signal. That is, when the BS obtains ILI information or measures ILI through use of the MAI information or the MAI reference signal, the BS may determine whether ILI is greater than a predetermined threshold (step S1500).

When ILI is excessively greater than the predetermined threshold, for example, when it is determined that signals may not be restored from all layers through IC although the layers in which interference occurs are assigned to a single UE, the BS may remove at least one of the layers in which interference occurs so as to not use the layer (step S1520).

Conversely, when the ILI is less than or equal to the predetermined threshold, the BS may assign the layers that mutually interfere with one another to a single UE (step S510).

Although the embodiments of the present invention have been described based on a case where two UEs (UE0 and UE1) perform multiple access with respect to the BS 20, the embodiments of the present invention may be applicable to a case where two or more UEs perform multiple access with respect to the BS 20.

For example, when three UEs perform multiple access with respect to the BS 20 and interference occurs between layers of two UEs among layers assigned to the three UEs, the embodiments of the present invention may be applicable to the case in the same manner as the descriptions provided in the foregoing.

As another example, when interference occurs among at least three layers assigned to the three UEs, the three layers in which interference occurs may be assigned to one of the three UEs, or two layers may be assigned to one UE and a remaining UE may be assigned to another UE. Although a number of UEs that performs multiple access with respect to a BS increases, the example embodiments may be applicable in the same manner as the descriptions provided in the foregoing.

Accordingly, when interference occurs between layers assigned to each UE, the layers in which interference occurs may be assigned to a single UE, and the corresponding UE may perform IC on the layers that cause interference when a signal is received, so as to reduce ILI. Accordingly, the BS may maximize a throughput of a UE.

That is, the BS may concentrate on reducing ILI occurring in layers assigned to different UEs, and may control ILI through IC performed with respect to a UE and thus, may maximally assure a throughput of the whole wireless system and may reduce interference in the whole system.

Even if it was described above that all of the components of the embodiments of the present invention are coupled as a single unit or coupled to be operated as a single unit, the present invention is not necessarily limited to such an embodiment. That is, among the components, one or more components may be selectively coupled to be operated as one or more units.

In addition, although each of the components may be implemented as an independent hardware, some or all of the components may be selectively combined with each other, so that they can be implemented as a computer program having one or more program modules for executing some or all of the functions combined in one or more hardware. Codes and code segments forming the computer program can be easily conceived by an ordinarily skilled person in the technical field of the present invention.

Such a computer program may implement the embodiments of the present invention by being stored in a computer readable storage medium, and being read and executed by a computer. A magnetic recording medium, an optical recording medium, a carrier wave medium, or the like may be employed as the storage medium.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A base station (BS) in a wireless communication system in which at least two user equipments (UEs) perform multiple access with respect to the BS, the BS comprising:
a layer composition unit to arrange layers so that at least one layer is assigned to each of the at least two UEs; and
a layer change unit to receive information associated with interference between layers of the at least two UEs, and to change the assignment of layers, in which interference occurs, with respect to the at least two UEs.

2. The BS claimed in claim 1, wherein the layer change unit changes the layers so as to assign the layers, in which interference occurs, to at least one of the at least two UEs, or changes the layers so as to remove one of the layers when a degree of interference between the layers of the at least two UEs is high.

3. The BS claimed in claim 1, further comprising:
a layer mapper to map at least two codewords to at least two layers,
wherein the layer mapper maps the layers, in which interference occurs, to the at least two UEs based on the assignment changed by the layer change unit.

4. The BS claimed in claim 1, wherein the layer composition unit receives a channel status report from each of the at least two UEs, and arrange the layers to be assigned to the at least two UEs.

5. The BS claimed in claim 1, wherein the layer change unit changes the layers by receiving multiple access interference (MAI) information from each of the at least two UEs or by receiving a multiple access reference signal from each of the at least two UEs and measuring MAI information.

6. The BS claimed in claim 4, wherein the channel status report is at least one piece of channel quality information (CQI), precoder matrix information (PMI), and channel status information (CSI).

7. The BS claimed in claim 2, wherein, when the degree of interference between the layers of the at least two UEs is high, signals transmitted through the layers, in which interference occurs, are not restored although all the layers are assigned to one of the at least two UEs.

8. A communication method for a base station (BS) to communicate with user equipments (UEs) in a wireless communication system in which at least two UEs perform multiple access with respect to the BS, the method comprising:
assigning at least one layer to each of the at least two UEs so as to communicate with the at least two UEs; and
assigning layers in which interference occurs to at least one of the at least two UEs when interference occurs between the layers of the at least two UEs.

9. The method of claim 8, wherein assigning of the layers in which interference occurs to at least one of the at least two UEs corresponds to at least one of:
assigning all the layers in which interference occurs to a UE that requires a higher data rate from among the at least two UEs;
assigning all the layers in which interference occurs to a UE of which layers, in which interference does not occur, have a smaller throughput from among the at least two UEs when the layers in which interference does not occur exist;
assigning all the layers in which interference occurs to a UE of which layers, in which interference does not occur, have a larger throughput from among the at least two UEs when the layers in which interference does not occur exist; and
assigning all the layers in which interference occurs to a UE to which only one layer is assigned.

10. The method as claimed in claim 8, wherein, when the layers in which interference occurs are assigned to at least one of the at least two UEs, the layers in which interference occurs are determined by receiving multiple access interference (MAI) information from each of the at least two UEs or by receiving a MAI reference signal from each of the at least two UEs and measuring MAI information.

11. The method as claimed in claim 8, further comprising:
receiving a channel status report from each of the at least two UEs.

12. The method as claimed in claim 8, wherein channel status report information is at least one piece of channel quality information (CQI), precoder matrix information (PMI), and channel status information (CSI).

13. A communication method for a base station (BS) to communicate with user equipments (UEs) in a wireless communication system in which at least two UEs perform multiple access with respect to the BS, the method comprising:
assigning at least one layer to each of the at least two UEs so as to communicate with the at least two UEs; and
assigning layers in which interference occurs to at least one of the at least two UEs when interference occurs between the layers of the at least two UEs, or removing one of layers in which interference occurs when interference between the layers of the at least two UEs is greater than a predetermined threshold value.

14. The method as claimed in claim 13, wherein, when a degree of interference between the layers of the at least two UEs is high, signals transmitted through the layers in which interference occurs are not restored although all the layers are assigned to one of the at least two UEs.

15. A multiple access method in a wireless communication system in which at least two user equipments (UEs) perform multiple access with respect to a base station (BS), the method comprising:
determining that interference occurs between layers of the at least two UEs when at least one layer is assigned to each of the at least two UEs; and
assigning the layers in which interference occurs to at least one of the at least two UEs.

16. A base station (BS) in a wireless communication system in which at least two user equipments (UEs) perform multiple access with respect to the BS, the BS comprising:
a layer mapper to assign at least one layer to each of the at least two UEs or to change an assigned layer based on a channel status report associated with at least one desired layer, received from each of the at least two UEs; and
a precoder to perform, based on the channel status report, precoding of data symbols mapped to a layer that is assigned or changed by the layer mapper.

17. The BS as claimed in claim 16, wherein the channel status report includes at least one of precoder matrix information (PMI) indicating a precoding scheme or a precoding matrix appropriate for a downlink channel associated with the at least one layer desired by the at least two UEs, and expected channel quality information (CQI) of the at least one desired layer.

18. The BS as claimed in claim 17, wherein a number of the at least one layer desired by the at least two UEs is two or more.

19. The BS as claimed in claim 16, wherein the layer mapper assigns at least one layer to each of the at least two UEs or changes an assigned layer based on interference information associated with the at least one desired layer, received along with the channel status report from each of the at least two UEs.

20. A communication method for a base station (BS) in a wireless communication system in which at least two user equipments (UEs) perform multiple access with respect to the BS, the method comprising:
performing layer-mapping that assigns at least one layer to each of the at least two UEs or changes an assigned layer based on a channel status report associated with at least one desired layer, received from each of the at least two UEs; and
precoding, based on the channel status report, data symbols mapped to a layer that is assigned or changed by a layer mapper in the layer-mapping, and transmitting the precoded data symbols to the at least two UEs.

21. The communication method as claimed in claim 20, wherein the channel status report includes at least one of precoder matrix information (PMI) indicating a precoding scheme or a precoding matrix appropriate for a downlink channel associated with the at least one layer desired by the at least two UEs, and expected channel quality information (CQI) of the at least one desired layer.

22. The method as claimed in claim 21, wherein a number of the at least one layer desired by the at least two UEs is two or more.

23. The method as claimed in claim 20, wherein the layer-mapping comprises:
assigning at least one layer to each of the at least two UEs or changing an assigned layer based on interference information associated with the at least one desired layer, received along with the channel status report from each of the at least two UEs.

24. A communication method for a user equipment (US) in a wireless communication system in which at least two UEs perform multiple access with respect to a base station (BS), the method comprising:
reporting, to the BS, a channel status report associated with at least one desired layer; and
receiving, from the BS, a signal that is mapped to the at least one desired layer based on the channel status report or a signal that is mapped to the at least one layer changed based on the channel status report.

25. The method as claimed in claim 24, wherein the channel status report includes at least one of precoder matrix information (PMI) indicating a precoding scheme or a precoding matrix appropriate for a downlink channel associated with at least one desired layer and expected channel quality information (CQI) of the at least one desired layer.

26. The method as claimed in claim 25, wherein a number of the at least one desired layer is two or more.

27. The method as claimed in claim 24, wherein reporting comprises:
additionally reporting, to the BS, interference information associated with the at least one desired layer along with the channel status report.
